(19) United States
(12) Patent Application Publication
(10) Pub. No.: US 2025/0035248 A1
(43) Pub. Date: Jan. 30, 2025

(54) LINING HOSE FOR THE REHABILITATION OF FLUID-CARRYING PIPE SYSTEMS

(71) Applicant: RELINEEUROPE GMBH, Rohrbach (DE)

(72) Inventors: Barbara SOLZBACHER, Rohrbach (DE); Frank MERSMANN, Rohrbach (DE)

(21) Appl. No.: 18/714,418

(22) PCT Filed: Nov. 29, 2022
(86) PCT No.: PCT/EP2022/083748

§ 371 Date: May 29, 2024

(30) Foreign Application Priority Data
Nov. 30, 2021 (DE) 10 2021 131 472.0

(51) Int. Cl. F16L 55/165; B32B 1/08; B32B 5/02; B32B 5/26; B32B 27/12

(52) U.S. Cl. CPC F16L 55/1656; B32B 1/08; B32B 5/022; B32B 5/265; B32B 27/12; B32B 2260/023; B32B 2260/046; B32B 2307/7242; B32B 2307/7246; B32B 2597/00

(57) ABSTRACT

The invention relates to a liner tube for the rehabilitation of fluid-conducting systems, comprising at least one tubular layer, which is made of fibre bands saturated with a curable acrylate resin, silicate resin, unsaturated polyester resin, or vinyl ester resin, and at least one further tubular layer made of fibre bands saturated with a photochemically curable epoxy resin, the further tubular layer being in indirect or direct contact with the first tubular layer and the liner tube having an inner tubular layer which is based on a thermoplastic and which, in the installed state, is in contact with the fluid medium.

The present invention relates to a lining hose for the rehabilitation of fluid-carrying systems.

Lining hoses for the rehabilitation of fluid-carrying systems, comprising at least one tubular layer made of fiber bands impregnated with a curable resin, are known and described in the literature. Unsaturated polyester resins, vinyl ester resins, or epoxy resins are used as resins.

The lining hoses according to WO 95/04646 usually comprise an opaque outer protective film, an inner film that is permeable at least to certain wavelength ranges of electromagnetic radiation, and at least one fiber band impregnated with a curable resin, which is arranged between the inner film and the outer film.

The outer film hose is intended to prevent the resin used for impregnation from leaking out of the fiber hose and entering the environment. This requires good sealing and bonding of the outer film hose to the resin-impregnated fiber hose.

From WO 00/73692 A1, a lining hose is known, comprising an inner film hose, a resin-impregnated fiber band, and an outer film hose, which is laminated on its inner side (i.e., the side facing the resin-impregnated fiber band) with a nonwoven fabric.

From DE 10 2014 112 600, short liners with an integrated hat profile for rehabilitating channels with branches are known, wherein the hat profile consists of at least one layer and the short liner consists of multiple layers, which have at least one recess at the same location, and at least one flange of the hat profile extends between at least two layers of the short liner. The multiple layers of the short liner can be laid on top of each other, with a single layer being impregnated with a polyester resin and another layer being impregnated with an epoxy resin.

Often, for the production of such lining hoses, resin-impregnated fiber bands are wound helically and overlapping onto an inner film hose. The outer film hose is then also wound helically and overlapping around the resin-impregnated fiber hose.

The inner hose itself is wound around a mandrel for simplified production. Alternatively, for example, WO 95/04646 discloses that a prefabricated inner film hose can be inflated and serve as a mandrel itself. Such a prefabricated inner film hose is made from a film band, whose film edges are joined together by welding or gluing to form the inner film hose.

The lining hoses described in the aforementioned prior art for the rehabilitation of fluid-carrying systems do not meet all requirements satisfactorily.

Accordingly, the object of the present invention was to provide lining hoses which can be used for the rehabilitation of fluid-carrying systems and which have improved properties.

The object of the present invention is achieved by lining hoses according to claim 1.

Preferred embodiments of the invention can be found in the dependent claims and the following detailed description.

Furthermore, the invention relates to the use of the lining hoses according to the invention for the rehabilitation of fluid-carrying systems.

The lining hoses according to the invention for the rehabilitation of fluid-carrying systems comprise at least a first tubular layer made of fiber bands impregnated with a curable unsaturated polyester or vinyl ester resin and at least one further tubular layer made of fiber bands impregnated with a photochemically curable epoxy resin, wherein the further tubular layer is in direct or indirect contact with the first tubular layer, and the lining hose further comprises a tubular layer based on a thermoplastic material, which is in contact with the fluid medium when installed.

Under the term fluid-carrying systems in the context of the present invention, all types of systems for the transport of liquid or gaseous media are to be understood. Examples include pipelines of any kind, piping systems for the transport of gaseous or liquid (fluid) media in chemical plants and production facilities, pressure water pipes, drinking water pipes, or wastewater systems, which are laid underground or out of sight, as well as above ground and visible. There are no particular restrictions regarding the design, diameter, or material of the systems to be rehabilitated.

The choice of material is determined by the fluid (gaseous or liquid) media to be transported in the systems; their properties ultimately also determine the service life of such systems and the need for rehabilitation, which can be carried out with the lining hoses according to the invention.

The lining hoses according to the invention for the rehabilitation of fluid-carrying systems comprise at least one tubular layer made of fiber bands impregnated with a curable acrylate, silicate, unsaturated polyester, or vinyl ester resin.

As fiber bands to be impregnated with the resin, any products known to those skilled in the art in the form of fabrics, knits, scrims, mats, or nonwovens, which may contain fibers in the form of long continuous fibers or short fibers, are generally usable in the lining hoses according to the present invention.

Corresponding products are well known to those skilled in the art and are commercially available in great variety from various manufacturers.

Fabrics are generally understood to be flat textile products made from at least two intersecting thread systems, which cross each other at an angle in the fabric surface pattern. This angle is preferably approximately or exactly 90°. The two thread systems are referred to as warp and weft, with the warp threads often running parallel or nearly parallel to the lengthwise edge of the fabric. However, systems are also conceivable in which the warp threads run at any angle relative to the lengthwise edge of the fabric and the weft threads run approximately perpendicular to them. Within the scope of the present invention, “approximately perpendicular” is understood to mean an angle between the warp and weft threads in the range of 60 to 120°.

Knits are generally understood to be textile products created by forming loops.

Fiber scrims are a processing variant of fibers where the fibers are not woven but are aligned parallel to each other, embedded in a chemical carrier substance (the matrix), and typically fixed in place by top and bottom cover films, and possibly by a stitching thread or an adhesive. Due to the parallel alignment of the fibers, fiber scrims exhibit pronounced anisotropy of strengths in the direction of orientation and perpendicular to it, which can be of interest for certain applications.

A nonwoven fabric consists of loosely assembled fibers that are not yet bonded together. The strength of a nonwoven fabric relies solely on the inherent adhesion of the fibers, but can be influenced by further processing. To be able to process and use the nonwoven fabric, it is typically consolidated, for which various methods can be applied.

Nonwoven fabrics differ from woven or knitted fabrics, which are characterized by a specific arrangement of individual fibers or threads determined by the manufacturing process. In contrast, nonwoven fabrics consist of fibers whose arrangement can only be described using statistical methods. The fibers lie randomly in the nonwoven material. The English term “nonwoven” (not woven) clearly distinguishes them from woven fabrics. Nonwoven fabrics are differentiated based on fiber material (e.g., the polymer in synthetic fibers), bonding methods, fiber type (staple or continuous fibers), fiber fineness, and fiber orientation. The fibers can be laid in a defined preferred direction or be entirely randomly oriented, as in a randomly laid nonwoven fabric.

When the fibers have no preferred direction in their orientation, the fabric is referred to as isotropic. If the fibers are arranged more frequently in one direction than in another, this is referred to as anisotropy.

Within the scope of the present invention, felts are also to be understood as fiber bands in the sense of the invention. A felt is a flat structure made of a disordered, difficult-to-separate fibrous material. Essentially, felts are nonwoven textiles. Felts made from synthetic and plant fibers are typically produced by dry needling (so-called needle felts) or by consolidation with water jets emerging from a nozzle bar under high pressure. The individual fibers in the felt are tangled together in a disordered manner.

Needle felt is usually produced mechanically with numerous barbed needles, where the barbs are arranged inversely to those of a harpoon. This process presses the fibers into the felt, and the needle can be easily withdrawn. By repeated needling, the fibers become entangled, and they may subsequently be post-treated chemically or with steam.

Like nonwoven fabrics, felts can be made from practically all natural or synthetic fibers. In addition to needling, or as a complement to it, fibers can also be entangled with a pulsed water jet or with a binder. These latter methods are particularly suitable for fibers without a scaly structure, such as polyester or polyamide fibers.

Felts have good temperature resistance and are generally moisture-resistant, which can be particularly advantageous when used in liquid-carrying systems.

For the lining hoses according to the invention, glass fiber fabrics or glass fiber scrims are preferably used.

According to a preferred embodiment, the lining hoses according to the invention have at least two different fiber bands impregnated with a curable acrylate, silicate, unsaturated polyester, or vinyl ester resin, wound over each other in the radial direction.

The at least two different fiber bands can differ in at least one of the parameters: fiber embedding, fiber orientation, fiber length, or fiber type.

Within the scope of the present invention, fiber embedding refers to the manner in which the fibers are incorporated into a carrier material.

The fiber bands used are selected so that the lining hose, on the one hand, has a property profile optimized for the specific application and, on the other hand, allows for the simplest possible manufacturability using existing equipment for producing such lining hoses.

By combining the use of several different fiber bands with varying structures in terms of fiber type, fiber length, fiber embedding, or fiber orientation, the property profile can be individually tailored to the specific application without requiring extensive modifications to the equipment used for manufacturing. By choosing the order in which the at least two different fiber bands are wound, the radial and longitudinal profile of the lining hoses according to the invention can be individually designed and optimally adapted to the specific application.

The length of the fibers used is not subject to any particular restriction, meaning that both so-called long fibers and short fibers or fiber fragments can be used. The properties of the corresponding fiber bands can also be adjusted and controlled over a wide range based on the length of the fibers used.

There is also no restriction on the type of fibers used. By way of example only, these can include glass fibers, carbon fibers, or synthetic fibers such as aramid fibers, or fibers made from thermoplastic plastics such as polyesters, polyamides, or polyolefins (e.g., polypropylene), or a combination of these fiber types, all of which are known to those skilled in the art with their properties and are commercially available in great variety. For economic reasons, glass fibers are usually preferred; however, if special heat resistance is important, aramid fibers or carbon fibers can be used, which can offer advantages over glass fibers in terms of strength at higher temperatures.

In some cases, it has proven advantageous if a first resin-impregnated fiber band is selected from fabrics, knits, scrims, mats, felts, or nonwovens, with the length of the fibers chosen according to the desired application. For instance, the first resin-impregnated fiber band could be a fiber scrim made of parallel-oriented continuous fibers, preferably parallel-oriented continuous glass fibers. It is advantageous if the continuous fibers are essentially oriented perpendicular to the longitudinal direction of the resin-impregnated fiber band. Such a first fiber band can preferably be combined with a second fiber band in which the fibers are arranged randomly in a chaotic fiber mat. The first fiber band gives the lining hose very good longitudinal strength, which is beneficial when installing in the systems to be rehabilitated. The second fiber band with randomly oriented fibers in the form of a chaotic fiber mat stabilizes the inner surface through high resin absorption and avoids pores on the inner surface, which could lead to damage during prolonged contact with aggressive media. On the other hand, the use of the oriented fiber scrim reduces the risk that the fiber mat will be pulled apart during impregnation, leading to uneven impregnation. Also, static requirements for the liner make this design preferred.

In a first wound resin-impregnated fiber band, the fiber scrim, according to one embodiment of the invention, can already be needled or sewn with a chaotic fiber mat, meaning that the first and any subsequently wound fiber bands can also have a multilayer structure. It has proven advantageous in some cases if at least one of the fiber bands wound onto a first fiber band has a multilayer structure in such a way that between two layers of randomly oriented fibers, an intermediate layer with fibers cut parallel to the longitudinal direction of the fiber band is included, which preferably have a length in the range of 2 to 60 cm, preferably from 3 to 30 cm.

According to another embodiment, the lining hoses according to the invention have a resin-impregnated fiber hose made by winding at least one fiber band with fibers oriented essentially perpendicular to the longitudinal direction of the fiber band and at least one other fiber band with fibers oriented parallel to the longitudinal direction of the fiber band.

According to another embodiment, a nonwoven fabric is used as at least one first resin-impregnated fiber band, which can be combined with any other fiber band of the types described above. Examples include glass nonwovens, polyolefin nonwovens such as polyethylene or polypropylene nonwovens, polyester nonwovens such as polyethylene terephthalate nonwovens (PET nonwovens), or polyacrylonitrile nonwovens (PAN nonwovens). Essentially, any nonwoven fabric is suitable. In some cases, plastic nonwovens have proven advantageous.

Finally, according to another embodiment, one of the fiber bands used is a felt of the type described above, which can in turn be combined with at least one other fiber band of the types described above.

In principle, it is possible to combine any types of fiber bands to best achieve the desired property profile for the intended application. For example, fiber bands with the same type of fiber embedding (e.g., two fiber scrims or two fiber fabrics) can be used, containing fibers of different chemical compositions, different orientations, or different lengths. For instance, short fibers in one fiber band can be combined with long fibers in at least one other fiber band wound on top of it, or fabrics can be combined with nonwovens, mats, or knits. It is also possible to use two fiber fabrics with fibers of the same type of embedding and the same orientation and length but different chemical compositions. This provides a wide range of variations within which the expert can tailor the properties of the lining hose for the individual application.

Starting from the desired property profile, the expert selects the appropriate fiber bands for the lining hoses according to the invention using their knowledge of the properties of the different types of fiber bands and is thus able to provide products optimally adapted to the individual application case.

The resins used for impregnating the fiber bands of the first tubular layer are curable acrylate, silicate, unsaturated polyester (UP), or vinyl ester resins (VE), which can be dissolved in styrene and/or a (meth) acrylate ester. Suitable resins are generally known to the expert and commercially available in various formulations.

Silicate resins are inorganic resins consisting essentially of the elements silicon and oxygen, which are spatially cross-linked via a crystalline framework.

Silicate materials, which still exhibit solubility in water, contain Si—OH groups instead of Si—O—Si linkages to varying degrees and are often referred to as water glass.

Two Si—OH groups can form a bond by releasing water. This reaction can be accelerated by suitable catalysts.

Schematically, the reaction can be represented as follows:

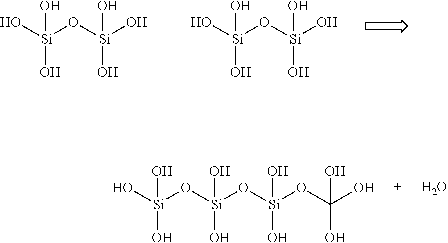 [SMILES: O[Si](O)(O)O[Si](O)(O)O ; O[Si](O)(O)O[Si](O)(O)O ; OC(O)(O)O[Si](O)(O)O[Si](O)(O)O[Si](O)(O)O ; O]

In principle, a corresponding reaction is possible for all Si—OH groups in water glass, where large insoluble molecules form from individual soluble water glass molecules (the product hardens). This results in a solid silicate material with similarities to glass, which is why the term “silicate resins” is chosen for such systems.

Glass is known to be relatively brittle and can only be deformed to a limited extent. To improve deformability, additional components are mixed with water glass, resulting in blends. An example of suitable blend components are polyurethane/polyurea systems that can be cured using diisocyanates.

Just as an example, three-component systems based on silicate-isocyanate consisting of resin, hardener, and catalyst are commercially available from several suppliers. The processing time of such resin systems is adjusted by the type and amount of catalyst and hardener used. Such systems, for example, marketed under the name MaxPatch by the company RS Technik GmbH, are known for their good impregnation of fiber mats or nonwovens.

Acrylate resins typically consist of (meth)acrylic monomers as the main component and can be modified, for example, with styrene. Acrylates that cure via photoinitiation are one-component reactive resins, with their radical polymerization occurring through UV or visible light. Also suitable are acrylate resins that can be cured using thermal energy or a combination of thermal energy and electromagnetic radiation.

Unsaturated polyester (UP) resins are produced by esterifying polyunsaturated dicarboxylic acids with diols, yielding low molecular weight products which, upon curing, typically polymerize with vinyl compounds (especially styrene) as comonomers to form high molecular weight three-dimensional networks.

Mixtures of saturated and unsaturated bifunctional carboxylic acids or their anhydrides can be used as the acid component of UP resins. Acid components such as adipic acid, glutaric acid, phthalic acid, isophthalic acid, and terephthalic acid, as well as their reactive derivatives, can be employed. Preferred unsaturated acids include maleic acid or its anhydride, fumaric acid, and Diels-Alder adducts of maleic anhydride and cyclopentadiene. Diols preferably used for crosslinking UP resins include ethylene glycol, propylene glycol, dipropylene glycol, diethylene glycol, 2,2-dimethyl-1,2-propanediol, 1,4-butanediol, 2,2,4-trimethyl-1,3-pentanediol, or bisphenol A. Comonomers necessary for crosslinking UP resins can also simultaneously serve as solvents for the low molecular weight oligomers; styrene, for example, is commonly used in many UP resins. Other examples of suitable comonomers include methylstyrene, vinyltoluene, or methyl methacrylate.

Bifunctional monomers such as diallyl phthalate or divinylbenzene may also be added.

Other components of UP resins such as hardeners, polymerization initiators, accelerators, plasticizers, and the like are known to those skilled in the art and are described in the literature, making further elaboration unnecessary.

Vinylester resins (also referred to as VE resins), another group suitable for impregnating the fiber tapes of at least one first tubular layer, are obtained by first producing an epoxy oligomer in a first stage. This oligomer contains terminal vinylester groups such as acrylate or methacrylate groups, thereby possessing reactive double bonds. In a second step, crosslinking occurs, typically utilizing styrene as a solvent and crosslinking agent. The crosslinking density of VE resins is generally lower than that of UP resins due to the presence of fewer reactive double bonds.

In VE resins, the backbone of the oligomer preferably comprises aromatic glycidyl ethers of phenols or epoxidized novolaks. These are preferably esterified with (meth)acrylic acid at the ends.

The reactive resins used for impregnating the fiber tapes can be cured thermally (usually through peroxide catalysts) or by radiation, e.g., UV light, with photoinitiators as described, for example, in EP-A 23623. Combination curing with a peroxide initiator used for thermal curing in combination with photoinitiators is also possible and has proven advantageous, especially for large wall thicknesses of the lining hoses, as described, for instance, in EP-A 1262708. A method for such combination curing is described, for example, in EP-A 1262708.

After impregnation, the resin can conveniently be thickened, as described, for example, in WO-A 2006/061129. This increases the viscosity of the resin, improving the handling and winding of the fiber tapes used.

In addition to at least one first tubular layer consisting of fiber tapes impregnated with acrylate, silicate, unsaturated polyester, or vinylester resin, the lining hoses according to the invention contain at least one further tubular layer consisting of fiber tapes impregnated with a photochemically curable epoxy resin, wherein the further tubular layer is directly or indirectly in contact with the at least one first tubular layer.

In the context of the present invention, being in indirect contact should be understood to mean that the contact can also be made via additional interposed elements which are themselves bonded to the resin-impregnated fiber tape or the resin-impregnated fiber tapes.

The materials described above for the fiber tapes of the at least one first tubular layer can be used as the material for the fiber tapes in the at least one further tubular layer. For further details, reference is made to the corresponding preceding descriptions to avoid repetition.

The fiber tapes of the at least one further tubular layer are impregnated with a curable epoxy resin.

Preferably, photochemically curable epoxy resins, particularly preferably cationically curable epoxy resins, are used.

Photochemical cationic curing is based on the principle that salts of certain photosensitive compounds can trigger cationic polymerizations photochemically. Cationically polymerizable monomers range from vinyl to ring-opening polymerizable heterocyclic monomers; in principle, any cationically polymerizable monomer, when using suitable initiators, can also be photoinitiated cationically polymerized.

Photochemically induced cationic polymerization overcomes the problem of the lack of latency of spontaneous cationic polymerization, which makes the production of spontaneously cationically curable products that are stable during storage largely impossible. The use of photochemical initiation allows the continuous in situ generation of the active species upon irradiation, leading to rapid and homogeneous curing at the desired time.

The active initiating species in cationic polymerization is a cation, usually a proton or a strongly electrophilic carbocation. Suitable cations include, for example, Lewis or Bronsted acids.

A variety of initiators are known for the photochemically initiated cationic polymerization of epoxides. Here, only aryl diazonium salts, aryl iodonium salts, diaryliodonium salts, diarylchloronium salts, diarylbromonium salts, triarylsulfonium salts, dialkylphenylacylsulfonium salts, phosphonium salts, N-alkoxy pyridinium salts, pyridinium salts, pyrylium salts, and thiapyrylium salts are mentioned as examples.

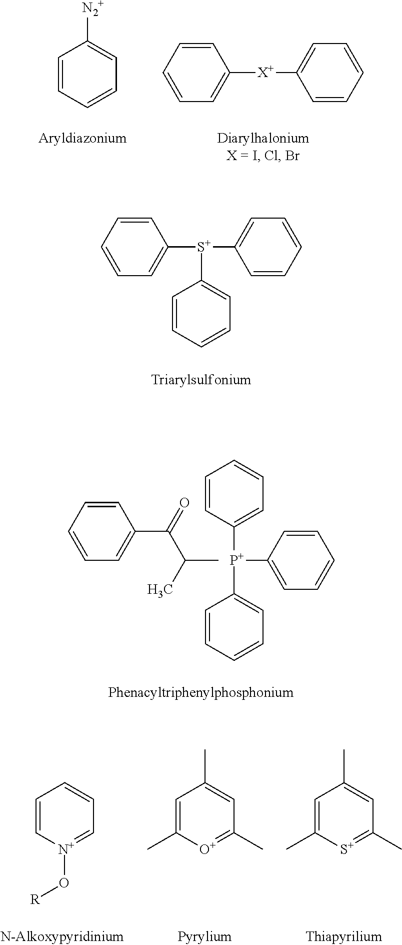

The anions of these photocatalytic initiator compounds should exhibit as low nucleophilicity as possible to avoid interference with the curing process. Typically, the curing speed, degree of polymerization, and achievable conversion follow the following hierarchy:

SbF₆₋₋>AsF₆₋>PF₆₋>>BF₄₋>>CF₃SO₃₋˜ClO₄₋>CI₋˜Br

In practice, hexafluoroantimonate, hexafluorophosphate, tetrafluoroborate, and hexafluoroarsenate have proven to be the most effective, with the first two being particularly preferred.

The cation is the light-absorbing component, and thus, the absorption maximum of the cation determines the wavelength required for irradiation. The sensitivity to the wavelength used for irradiation determines the extent to which the initiating species is formed, and thus, the curing. Ideally, the effective initiating species is formed with high yield at the lowest possible irradiance. Therefore, the initiator used should exhibit intense absorption bands in the range of the wavelength used for irradiation.

Particularly preferred as initiators are onium salts, which are also commercially available. Among diarylhalonium salts, diaryliodonium salts are preferred because they are easier to produce than the corresponding chloronium or bromonium salts and are generally thermally more stable. Suitable aryl iodonium salts are described, for example, in WO 96/13538, to which reference is made here for further details.

Other preferred photoinitiators include aryl diazonium and aryl sulfonium salts, as described, for example, in EP 770 608, to which reference is made here in this regard.

Aryl sulfonium salts generally exhibit slightly better absorption in the range of wavelengths greater than 300 nm than aryl iodonium salts. Furthermore, they are thermally very stable and easy to synthesize. However, their photosensitizing ability is generally lower than that of aryl iodonium salts.

Another group of potentially suitable initiators are benzothiazolium compounds, as described in the dissertation by Dr. Verenena Görtz (University of Mainz, 2005) entitled “Benzothiazolium Salts as Photoinitiators for Cationic Epoxide Polymerizations,” to which reference is made here for further details on these compounds.

Essentially, it is also possible to bind initiators to polymers. These can then act as latent cationic macroinitiators. Since initiators are typically ionic compounds, ionizable polymers are preferably used for this purpose. Such systems may offer advantages in terms of the initiator's solubility in the system to be cured, which can be desirable for some applications.

lonic polymers are fundamentally distinguished into polyelectrolytes (which have an ionic structure in each repeating unit), ionomers (which do not have an ionic structure in each repeating unit), and macroions with few ionic groups. Examples of such polymers are known to those skilled in the art, so detailed descriptions are unnecessary here.

The aforementioned initiators typically have absorption maxima at wavelengths ranging from 200 to 350 nm. Therefore, electromagnetic radiation in this wavelength range must be used for radiation curing. However, UV radiation is associated with certain risks due to its high energy content. Additionally, epoxy resins or their monomers themselves partially absorb strongly in this range, which can lead to insufficient formation of the required cations during application because the radiation is absorbed by the much more abundant monomer molecules.

In some cases, it is therefore desirable to use light for radiation curing in the wavelength range above 350 nm, particularly in the range of 360 to 800 nm, preferably from 380 to 700 nm. However, the absorption of the initiators described above in this wavelength range is sometimes insufficient to generate the cations required for cationic curing. In these cases, a combination of an initiator and a so-called sensitizer can be used.

Under the influence of actinic light (with a wavelength in the range of 360 to 800 nm), the sensitizer decomposes into radicals, which, through electron transfer or redox reactions from the initiators, generate the required cations, typically Lewis acids or Bronsted acids.

The effectiveness of an initiator system consisting of initiator and sensitizer depends on the ability of the initiator to accept the electron released by the sensitizer. Compounds with a relatively high reduction potential (such as iodonium salts) show a more pronounced increase in effectiveness when combined with sensitizers compared to initiators with relatively low reduction potential like arylsulfonium salts. Therefore, the choice of combination of initiator and sensitizer will be considered by the expert in accordance with these influencing factors.

Suitable sensitizers are generally known to those skilled in the art and described in the literature. Generally, sensitizers used in the cationic curing of dental application materials are suitable.

Preferred sensitizers include alpha-dicarbonyl compounds (WO 96/13538), alpha-hydroxyketones (US-B 6,245,827), acylphosphine oxides and diacylphosphine oxides (WO 01/44873), as well as aromatic polycyclic hydrocarbons and aromatic amines (DE-A 26 39 395).

A group of preferred alpha-dicarbonyl compounds are those of structure A(CO)(CO)B, where A and B can be the same or different and can be a hydrogen atom or a optionally substituted aryl, alkyl, alkaryl, or aralkyl group, or A and B together can form a substituted or unsubstituted cycloaliphatic, aromatic, or heteroaromatic ring. For specific examples, reference is made to WO 96/13538, particularly pages 14 and 15.

Preferred acylphosphine oxides as sensitizers are described in WO 01/44873. Preferred compounds include diphenyl (2,4,6-trimethylbenzoyl) phosphine oxide, available under the trade name Lucirin TPO® (BASF SE), or bis (2,4,6-trimethylbenzoyl) phenylphosphine oxide, also commercially available. Other preferred acylphosphine oxides have the general structure Ar—CO—P(═O)(Ar)2, where Ar represents an aromatic group (same or different).

By adding sensitizers, it becomes possible to perform curing with light of relatively low intensity. Additionally, they enable deeper penetration of light.

The weight ratio of initiator to sensitizer is generally in the range of 30:70 to 70:30, preferably in the range of 40:60 and 60:40.

The resin preferably contains 0.02 to 10, especially 0.05 to 5 wt. %, based on the total weight of the monomer components, of initiator or initiator system.

Such resins are obtainable from epoxy compounds with an average of more than one epoxy group per molecule, optionally with the co-use of other monomers containing hydroxyl groups. Additionally, preferred epoxy compounds include those containing hydroxyl groups in addition to the epoxy group within the molecule.

Suitable epoxides include, for example, compounds containing cyclohexene oxide groups such as epoxycyclohexanecarboxylates, as detailed in U.S. Pat. No. 3,117,099, which is referred to herein for specifics.

Another preferred group of epoxides are glycidyl ether derivatives, obtained, for example, by reacting phenol derivatives with multiple hydroxyl groups with epichlorohydrin. These include, in particular, the diglycidyl ethers of 2,2-dimethyl-2,2-di-(4-hydroxyphenyl)-propane (bisphenol A) or 2,2-di (4-hydroxyphenyl)-propane (bisphenol F). Aliphatic epoxy compounds are also suitable, e.g., epoxidized fatty acid derivatives.

Specifically, exemplary compounds include octadecylene oxide, styrene oxide, cyclohexene oxide, vinylcyclohexene oxide, limonene dioxide, 1,omega-bis (3,4,-epoxycyclohexylmethyloxy)alkanes, glycidol, glycidyl methacrylate, vinylcyclohexene dioxide, 3,4-epoxy-6-methylcyclohexylmethyl-3,4-epoxy-6-methyl-cyclohexene carboxylate, 3,4-epoxycyclohexylmethyl-3,4-epoxycyclohexene carboxylate, bis-(3,4-epoxy-6-methylcyclohexylmethyl)adipate, bis-(3,4-epoxy-4-methylcyclohexanecarboxylic acid)hexyl diester, 1,3-bis (3,4-epoxycyclohexylethyl)tetramethyldisiloxane, and bis-(2,3-epoxycyclopentyl)ether, some of which are depicted below:

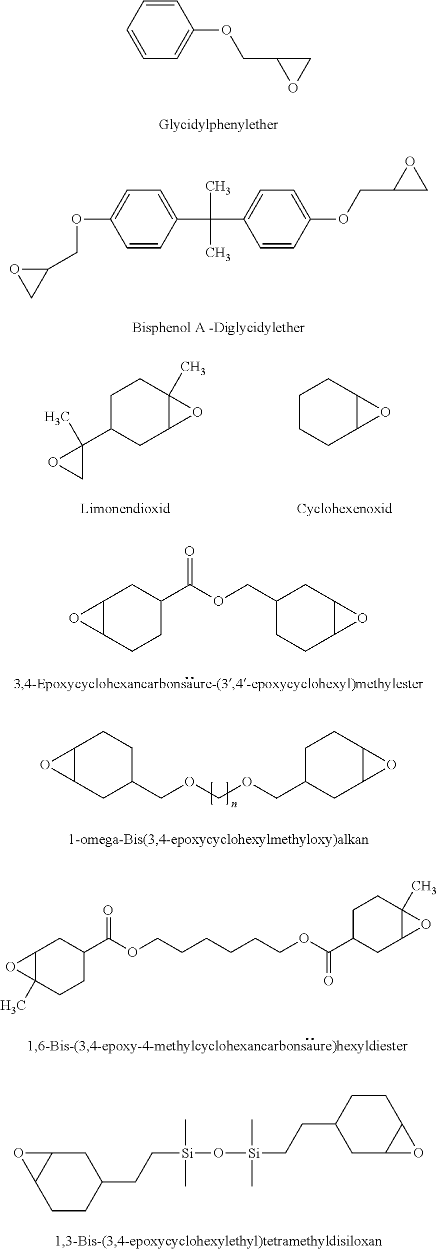

During polymerization, the active cation opens the epoxy ring, initiating a continuous polymerization with chain growth.

Corresponding products are described in a variety of different variations in the literature and are commercially available.

To tailor the properties of epoxy resins specifically for the desired application, it has proven effective to use epoxy compounds with more than one epoxy group per molecule in combination with compounds containing more than one hydroxyl group per molecule. These mixtures result in better cured products due to chain transfer reactions. Therefore, the hydroxy compounds in such mixtures are often referred to as curing agents.

Particularly preferred representatives of compounds with more than one hydroxyl group per molecule are aliphatic alkylene glycols and polyoxyalkylene glycols. Further examples of suitable hydroxy compounds can be found in WO 96/13538, which is referred to herein for this purpose.

If combinations of epoxides with more than one epoxy group per molecule and compounds with more than one hydroxyl group per molecule are used, the equivalent ratio of epoxy groups to hydroxyl groups generally ranges from 0.1 to 10 to 10 to 0.1, preferably from 0.5 to 5 to 5 to 0.5, and especially from 0.7 to 1 to 1 to 0.7, with mixtures where the equivalent ratio is in the range of 0.9 to 1 to 1.1 to 1 being particularly preferred. A slight excess of hydroxyl groups has proven to be particularly advantageous.

Instead of a mixture of two different compounds, compounds containing both epoxy groups and hydroxyl groups in the same molecule can also be used. Such compounds are known to those skilled in the art, so further details are unnecessary here.

The epoxy resin in the lining tubes of the present invention may contain fillers to improve the mechanical properties of the cured liner (which should be transparent to the light used for irradiation), such as glass powder, aluminum hydroxide, or silicon dioxide.

In some cases, it may be advantageous for the resin to contain small amounts of an organic peroxide capable of initiating radical polymerization. This can assist curing in areas that are not reached by the radiation. Suitable peroxides are described in EP 1 262 708, which is referred to herein for details. However, a benefit of photochemically initiated cationic polymerization is that once the reaction is initiated, it continues even if the irradiation is interrupted or stopped. This allows curing in areas of the tube that are not directly reached by the light from the radiation source. The generated cations are sufficiently long-lived to sustain chain propagation without continuous irradiation. Nevertheless, it is advantageous to maintain irradiation until complete curing is achieved, as this allows the desired curing to be achieved in a shorter time.

The at least one additional tubular layer consisting of fiber tapes impregnated with a curable epoxy resin may be arranged on the surface of the first tubular layer that faces the surface in the installed state facing the flowing fluid medium, or may be arranged on the surface facing the flowing fluid medium in the installed state.

If the lining tube of the present invention has more than one tubular layer containing fiber tapes impregnated with an acrylic, silicate, unsaturated polyester, or vinyl ester resin, then the additional tubular layer containing fiber tapes impregnated with an epoxy resin can also be arranged between two layers impregnated with acrylic, unsaturated polyester, or vinyl ester resin.

Based on their expertise and considering the current requirements, the specialist will select the appropriate arrangement.

The width of the fiber tapes is generally not subject to any particular restrictions; fiber tapes with a width of 20 to 150, preferably 30 to 100, and especially 30 to 90 cm have proven to be suitable for a variety of applications.

The thickness of the fiber tapes in the lining tubes of the present invention also does not have any particular restrictions and is determined by the thickness of the lining tube required for the desired application. Thicknesses of the fiber tapes ranging from 0.01 to 1, especially 0.05 to 0.7 mm, have proven effective in practice.

The lining tubes of the present invention have an inner tubular layer, such as a potentially reinforced inner film tube, made of a thermoplastic material, which is in contact with the fluid when installed and can be removed after the installation of the lining tube or may remain in the pipeline system to be rehabilitated. This inner tubular layer may contain 0.01 to 40% by weight of nanoparticles, based on the total weight of the inner film tube.

Suitable thermoplastic materials for the inner tubular layer include all polymers that can be processed into films or film tubes of the required thickness or strength for the respective application. Additionally, if the curing is done photochemically, it should be noted that the products have sufficient permeability for the wavelength or wavelength range of the radiation used for curing. If the inner tubular layer is intended to remain in the rehabilitated system after curing, it must also have sufficient stability against the transported fluids as well as against the resin of the fiber tubes. In most cases, however, the inner tubular layer is removed after curing. In principle, polyolefins such as polyethylene or polypropylene, polyamides, polyesters such as polybutylene terephthalate, polyethylene terephthalate, or polyethylene naphthalate, polyvinyl chloride, polyacrylonitrile, or thermoplastic polyurethanes, or mixtures of these polymers, are suitable, considering these criteria. Thermoplastic elastomers are also generally suitable. Thermoplastic elastomers are materials in which elastic polymer chains are incorporated into thermoplastic material. Despite the absence of vulcanization required in classical elastomers, thermoplastic elastomers exhibit rubbery elastic properties, which can be advantageous in some applications. Examples include polyolefin elastomers or polyamide elastomers. Corresponding products are described in the literature and commercially available from various manufacturers, so detailed information is unnecessary.

In some applications, thermoplastic polyurethanes, polyamides, silicones, and olefin polymers or combinations of these thermoplastic materials have proven to be materials for the inner tubular layer.

Particularly suitable and preferred thermoplastic materials include, for example, polyolefins and/or polyamides or silicones, with film tubes based on composite films of polyolefins and polyamides having proven advantageous in certain applications. This is because they exhibit better barrier properties against styrene or acrylates, which are commonly used as solvents for the resins used, than pure polyethylene films. This helps to better prevent the escape of these solvents/monomers on the inside of the lining tube before curing.

According to one embodiment, the tubular layer in contact with the fluid medium in the installed state includes a barrier layer against monomers, gas, and/or water vapor. Silicones, for example, exhibit good barrier properties against water vapor.

According to one embodiment, the inner film tube may have reinforcement.

This is chosen to optimize the property profile for the respective application while also ensuring the simplest possible production of the lining tubes.

Preferably, the inner film tube has fiber-based reinforcement, particularly based on fiber tapes as described above, or a fleece.

The thickness of the reinforcement, such as the fleece, is advantageously in the range of 0.001 to 10 mm, particularly preferably in the range of 0.02 to 5 mm.

According to a particularly preferred embodiment, the fiber-based reinforcement is a glass fiber fabric or a glass fiber mat.

If curing is to occur after insertion into the piping system to be renovated by exposure to light, care must be taken to ensure that the materials used for the inner film tube are sufficiently transparent to the light used for irradiation so as not to impair or prevent curing. This is not relevant for thermal curing.

According to another preferred embodiment, the lining tubes of the present invention have at least one outer film tube based on a thermoplastic material.

Suitable outer film tubes for use in the lining tubes of the present invention are known and described in the literature. Examples include WO95/04646 and WO 00/73692, with the reinforced outer film tubes according to WO 00/73692 representing a preferred embodiment.

The lining tubes of the present invention are suitable for renovating fluid-conducting systems of any kind and enable rapid renovation while minimizing system downtime when they need to be taken out of service. Compared to the replacement of damaged parts, downtime is reduced. The lining tubes of the present invention can be particularly advantageously used for renovating such systems that are difficult to access for classic repairs or renovations involving part replacement, either because they are components of an overall device or because they are inaccessible, such as when they are buried in the ground. Examples include piping systems for transporting water or wastewater, which are often buried in the ground in cities and municipalities, frequently under roads or other traffic routes. When renovated by replacement, these pipelines must first be exposed through appropriate excavation work, and the traffic routes are inaccessible to traffic for longer periods, leading to significant disruptions, especially during high traffic volumes. In comparison, renovating such piping systems with the lining tubes of the present invention can be done in a few hours or days without extensive excavation work.

1. Lining tube for rehabilitation of fluid-conducting systems comprising at least a first tubular layer of fiber tapes impregnated with a curable acrylate, silicate, unsaturated polyester, or vinyl ester resin, and at least one additional tubular layer of fiber tapes impregnated with a curable epoxy resin, wherein the additional tubular layer is directly or indirectly in contact with the first tubular layer, and the lining tube comprises an inner tubular layer based on a thermoplastic material, which is in contact with the fluid medium when installed.

2. The lining tube according to claim 1, characterized in that the additional tubular layer is arranged on the surface of the first tubular layer, which, when installed, is opposite to the surface facing the fluid medium.

3. The lining tube according to claim 1, characterized in that the additional tubular layer is arranged on the surface of the first tubular layer, which, when installed, faces the fluid medium.

4. The lining tube according to claim 1, comprising at least two tubular layers of fiber tapes impregnated with a curable acrylate, unsaturated polyester, or vinyl ester resin, wherein the additional tubular layer of fiber tapes impregnated with a photochemically curable epoxy resin is arranged between two tubular layers of fiber tapes impregnated with a curable acrylate, unsaturated polyester, or vinyl ester resin.

5. Lining tube according to claim 1, characterized in that the unsaturated polyester resin is obtained by esterification of polyunsaturated carboxylic acids with diols and vinyl compounds.

6. Lining tube according to claim 1, characterized in that the vinyl ester resin is obtained by first producing an epoxy oligomer in a first stage, which is then cross-linked in a second stage.

7. Lining tube according to claim 1, characterized in that the inner tubular layer in contact with the fluid medium when installed is based on polyurethane, polyamide, silicone, olefin polymer, or combinations thereof.

8. Lining tube according to claim 1, characterized in that the inner tubular layer, when installed and in contact with the fluid medium, includes a barrier layer against monomers, gas, or water vapor.

9. The use of a lining tube according to claim 1 for the rehabilitation of fluid-conducting systems.

10. The use according to claim 9 for the rehabilitation of pipelines for water or wastewater or for the rehabilitation of pipelines in industrial production facilities.
